(19) United States
(12) Patent Application Publication
(10) Pub. No.: US 2006/0288568 A1
(43) Pub. Date: Dec. 28, 2006

(54) Device for fabricating a cellular sheath around a conductor

(76) Inventors: Pascal Clouet, Vigneux Sur Seine (FR); Jean-Francois Guinot, Bondoufle (FR)

Correspondence Address: SOFER HAROUN, L.L.P., Suite 910, 317 Madison Avenue, New York, NY, 10017, US

(21) Appl. No.: 11/203,421

(22) Filed: Aug. 11, 2005

(30) Foreign Application Priority Data
Aug. 27, 2004 (FR) 04 51 962

(51) Int. Cl. B23P 19/00; H01R 43/00

(52) U.S. Cl. 29/745; 29/825

(57) ABSTRACT

A device for fabricating an insulating material cellular sheath around a conductor. The device has a central guide including a longitudinal passage adapted to receive the conductor. The fabrication device further has a peripheral guide, an internal surface of the peripheral guide and an external surface of the central guide defining a passage adapted to receive the insulating material in a viscous state. The fabrication device further maintains a sleeve separate from the central guide and the peripheral guide. At least a portion of the sleeve is adapted to be placed between the central guide and the peripheral guide and includes an opening that opens onto the central guide and onto the peripheral guide.

### RELATED APPLICATION

This application is related to and claims the benefit of priority from French Patent Application No. 04 51962, filed on Aug. 27, 2004, the entirety of which is incorporated herein by reference.

### FIELD OF THE INVENTION

The present invention relates to a method and a device for fabricating a cellular sheath of a conductor. It relates more particularly, but in non-limiting manner, to fabricating intermediate dielectric sheaths for coaxial cables.

### BACKGROUND OF THE INVENTION

FIG. 1 shows an example of a prior art coaxial cable. The coaxial cable 10 generally comprises a central conductor 4 surrounded by an intermediate sheath 5, or “insulation” made of dielectric insulating material. The central conductor 4 may be solid or stranded, as shown in FIG. 1. A protective outer sheath 7 surrounds the intermediate sheath 5 and, where applicable, so does an additional braided, woven, or taped conductor 6.

The intermediate sheath must have specific dielectric properties for the coaxial cable to have the required attenuation characteristics, in particular at relatively high frequencies. To be more precise, the intermediate sheath is generally required to have a dielectric constant of less than about 1.8 and as close as possible to 1. The closer the dielectric constant is to 1, the higher the frequencies at which the coaxial cable can be used.

The dielectric constants of the insulating materials conventionally used in cablemaking, for example polyethylene or polytetrafluoroethylene (PTFE), have a value close to 2 when the insulating materials are used in solid form. To reduce the dielectric constant of the intermediate sheath, it is known in the art to use the insulating materials to provide sheaths in foam or cellular form.

Foam sheaths are made from an insulating material comprising a plurality of bubbles filled with air or a gas having a dielectric constant close to 1, so that the dielectric constant of the foam sheath is lower than the dielectric constant of the insulating material alone.

Cellular sheaths have cells extending in a rectilinear or helical manner along the coaxial cable. As shown in FIG. 1, walls 53, 51, and 54 separate the cells 52 from each other, from the central conductor 4, and from the protective outer sheath 7. The cells may be of various shapes.

The cells may be closed, as shown in FIG. 1, in other words each cell may be entirely surrounded by walls of insulating material.

The cells may instead open directly onto the conductor.

The cells are obtained by shaping the insulating material used by means of an extrusion device having appropriate openings and passages.

European Patent EP 0 803 878 describes a method and a device for fabricating the above type of cellular sheath. The fabrication device includes a central guide having a longitudinal passage for a conductor. The fabrication device also includes a coaxial die surrounding the central guide. An external surface of the central guide and an internal surface of the die define a passage for an insulating material in the viscous state. The die includes openings communicating with the passage. The openings are adapted to receive the insulating material in the viscous state and have a shape adapted to form cells. Thus the insulating material is shaped by extrusion and then applied to the conductor at a distance from the die such that the insulating material is under sufficient tension to prevent the walls of the cells collapsing because of the pressure drop at the outlet of the die.

The die includes a plurality of openings that form the cells, typically from four to six cells. A given die is therefore associated with a given configuration of the cellular sheath. To fabricate cellular sheaths with different configurations it is necessary to use a plurality of fabrication devices or to change the die of a given fabrication device.

### OBJECTS AND SUMMARY OF THE INVENTION

The device of the present invention for fabricating coaxial cables facilitates the fabrication of coaxial cables having cellular sheaths with different configurations using the same fabrication device.

The present invention consists in a device for fabricating an insulating material cellular sheath around a conductor. The fabrication device comprises a central guide including a longitudinal passage adapted to receive the conductor. According to the invention, the fabrication device further comprises a peripheral guide. An internal surface of the peripheral guide and an external surface of the central guide define a passage adapted to receive said insulating material in a viscous state. The fabrication device further comprises a sleeve separate from the central guide and the peripheral guide. At least a portion of the sleeve is adapted to be placed between the central guide and the peripheral guide and includes an opening that opens onto the central guide and onto the peripheral guide.

If the same fabrication device is used to fabricate cellular sheaths having different configurations, only the sleeve is replaced. The fabrication device of the invention therefore offers greater modularity than prior art devices.

Each opening of the sleeve communicates with the passage and therefore also receives the insulating material in the viscous state to form an insulating material wall.

The sleeve advantageously includes a plurality of openings to form a plurality of walls separating a plurality of cells from each other.

Alternatively, the sleeve includes only one opening.

An external surface of the sleeve and the internal surface of the peripheral guide define a peripheral passage adapted to receive the insulating material in the viscous state so that the cells formed in this way are separated from an external sheath at least by a peripheral wall corresponding to the peripheral passage. This is conventional and is not limiting on the invention.

An internal surface of the sleeve and an external surface of the central guide advantageously define a central passage adapted to receive the insulating material in the viscous state when the sleeve is placed between the central guide and the peripheral guide.

The insulating material in the viscous state received into the central passage thus forms a central wall isolating at least one cell from the conductor. The cells formed in this way are closed.

Alternatively, the sleeve may have dimensions such that when at least part of the sleeve is placed between the central guide and the peripheral guide the internal surface of the sleeve and the external surface of the central guide are sufficiently close together for the insulating material in the viscous state not to flow together between the sleeve and the central guide. A sleeve of this kind enables coaxial cables to be fabricated in which the cells of the cellular sheath open directly onto the conductor.

The sleeve may have various shapes.

In the conventional way, the sleeve comprises a plurality of radial openings to form radial walls separating the cells from each other. Broadly speaking, this kind of cellular sheath resembles a bicycle wheel.

As each radial opening of the sleeve opens onto an external surface of the sleeve, the sleeves of the invention are relatively easier to fabricate than are prior art dies.

Alternatively, the sleeve may comprise a central portion and a peripheral portion that are coaxial. An external surface of the central portion and an internal surface of the peripheral portion define an intermediate passage. The central portion and the peripheral portion each include a radial opening and preferably a plurality of radial openings. The radial openings of the central portion open onto the central guide and onto the peripheral portion. The radial openings of the peripheral portion open onto the central portion and onto the peripheral guide. The intermediate passage, the radial openings of the central portion and the radial openings of the peripheral portion are therefore adapted to receive the insulating material in the viscous state to form two layers of cells. The cells are separated from each other by an intermediate wall corresponding to the intermediate passage and by radial walls corresponding to the radial openings of the central portion and the peripheral portion, thereby forming a two-layer cellular sheath.

The present invention is not limited by the number of layers of cells in the cellular sheath.

Alternatively, the sleeve may comprise a plurality of non-rectilinear openings that cross one another so that the resulting cells are substantially the shape of a hexagon or a portion of an hexagon. This kind of cellular sheath is called a honeycomb sheath.

Alternatively, the cellular sheath fabrication device may comprise more than one central guide, so that the coaxial cable fabricated in this way comprises two substantially parallel conductors, for example. In this case, the fabrication device may comprise a single peripheral guide. The passage is defined by the external surfaces of the central guides and by the internal surfaces of the peripheral guide. The sleeve has a shape adapted to receive the central guides so that it can be placed between the central guides and the peripheral guide. The sleeve includes one or more openings that open onto one of the central guides and onto the peripheral guide. The sleeve may equally include a passage opening on either side of the central guides.

It is to be understood that the present invention is not limited by the number, shape or disposition of the opening or openings in the sleeve or by the shape of the sleeve itself.

Moreover, the sleeve may be rotated relatively slowly relative to the central guide about a longitudinal axis to form a cellular sheath having cells extending helicoidally along the coaxial cable.

Nevertheless, the sleeve preferably does not rotate about the longitudinal axis so that the cells that are formed extend in a rectilinear manner along the coaxial cable.

A fabrication device of the present invention advantageously includes a reduced pressure chamber adapted to communicate with a suction pipe and with the longitudinal passage of the central guide so that the insulating material is pressed against the conductor at the outlet of the central guide.

The reduced pressure chamber produces a reduced pressure at the outlet of the central guide, the effect of which is to press the central wall against the conductor.

Nevertheless, the present invention is not limited to the presence of the reduced pressure chamber or to the use of suction to produce a reduced pressure at the outlet of the central guide.

The sleeve preferably includes one or more longitudinal vents for at least partially balancing the pressure between the ends of the sleeve.

In the conventional way, the sleeve has the same number of vents and radial openings so that the pressure in each cell at the outlet of the sleeve is relatively high. The vents thus prevent the walls of the cells collapsing as a result of the reduced pressure.

The present invention is not limited by the presence of vents, of course. For example, the insulating material shaped by extrusion may be applied to the conductor at a distance such that the insulating material is relatively tensioned and cooled.

The fabrication device of the present invention advantageously includes a raised pressure chamber adapted to communicate with a blower pipe and with the or each vent.

The raised pressure chamber produces a raised pressure inside the cells to prevent the walls of the cells collapsing.

The present invention is not limited to the presence of the raised pressure chamber, of course, or to blowing into the cells.

The reduced pressure chamber and the raised pressure chamber are advantageously adapted to be disposed on a longitudinal axis of the fabrication device. The fabrication device advantageously also has a tube including a reduced pressure passage adapted to open into the reduced pressure chamber and into the longitudinal passage of the central guide.

The above kind of device for fabricating a cellular sheath is relatively compact and extends in a longitudinal direction.

The tube guarantees a seal between the portions of the fabrication device communicating with the raised pressure chamber and the portions of the fabrication device communicating with the reduced pressure chamber.

Moreover, the reduced pressure chamber and the raised pressure chamber are advantageously removably fixed, for example nested, so that a user can easily assemble and dismantle the fabrication device.

The present invention is not limited to the position of the reduced pressure chamber and the raised pressure chamber, of course, or by how the seal is guaranteed. Nevertheless, a fabrication device comprising the tube has the advantage of being relatively easy to assemble and/or dismantle.

The raised pressure chamber is advantageously placed between the reduced pressure chamber and a head of the fabrication device comprising the central guide. The tube advantageously crosses the raised pressure chamber.

Alternatively, the reduced pressure chamber is placed between the raised pressure chamber and the head of the fabrication device.

The present invention also provides a device for fabricating a cellular sheath around a conductor. The fabrication device comprises a central guide having a longitudinal passage adapted to receive the conductor and shaping means adapted to be disposed around the central guide. The shaping means comprise one or more openings adapted to receive the insulating material in a viscous state and one or more solid portions adapted to form one or more cells. Each solid portion has a vent. The fabrication device further includes a reduced pressure chamber and a raised pressure chamber. The reduced pressure chamber is adapted to communicate with a suction pipe and with the longitudinal passage so that the insulating material is pressed against the conductor at the outlet of the central guide. The raised pressure chamber is adapted to communicate with a blower pipe and with each vent. The reduced pressure chamber and the raised pressure chamber are adapted to be disposed on a longitudinal axis of the fabrication device. The fabrication device advantageously further has a tube including a reduced pressure passage adapted to open into the reduced pressure chamber and into the longitudinal passage of the central guide.

A device of the above kind, combining suction and blowing, respectively at the outlet of the central guide and at the outlet of the shaping means, guarantees adhesion of the insulating material to the conductor and prevents the cells collapsing; this means that the fabrication device controls the behaviour of the insulating material at the outlet of the central guide and at the outlet of the shaping means.

Moreover, the tube allows the reduced pressure chamber and the suction chamber to be placed on the longitudinal axis. The reduced pressure chamber and the raised pressure chamber are typically disposed one behind the other, the tube guaranteeing a seal.

The shaping means may comprise a peripheral guide and a sleeve. A portion of the sleeve is adapted to be placed between the central guide and the peripheral guide and comprises the solid portion or portions adapted to forms the cell or cells and one or more openings adapted to receive the insulating material in the viscous state. The insulating material in the viscous state is also received in a peripheral passage between the peripheral guide and the sleeve and where applicable in a central passage between the sleeve and the central guide.

Alternatively, the shaping means comprise a die having one or more openings adapted to receive the insulating material in the viscous state.

The present invention also provides a method of fabricating a cellular sheath around a conductor using the fabrication device of the invention. The method of the invention comprises a step of suction via the suction pipe and a step of blowing via the blower pipe, the suction step and the blowing step taking place conjointly.

### BRIEF DESCRIPTION OF THE DRAWINGS

The invention is described in more detail below with the aid of figures showing a preferred embodiment of the invention.

FIG. 1, already commended on, shows an example of a coaxial cable.

FIG. 2 is a view in cross section of an example of a preferred embodiment of a device of the invention for fabricating a cellular sheath.

FIG. 3 is a view in longitudinal section of an example of the preferred embodiment of a device of the invention for fabricating a cellular sheath.

FIG. 4 is a detailed view of a portion of an example of a second sleeve of the preferred embodiment of the present invention.

### MORE DETAILED DESCRIPTION

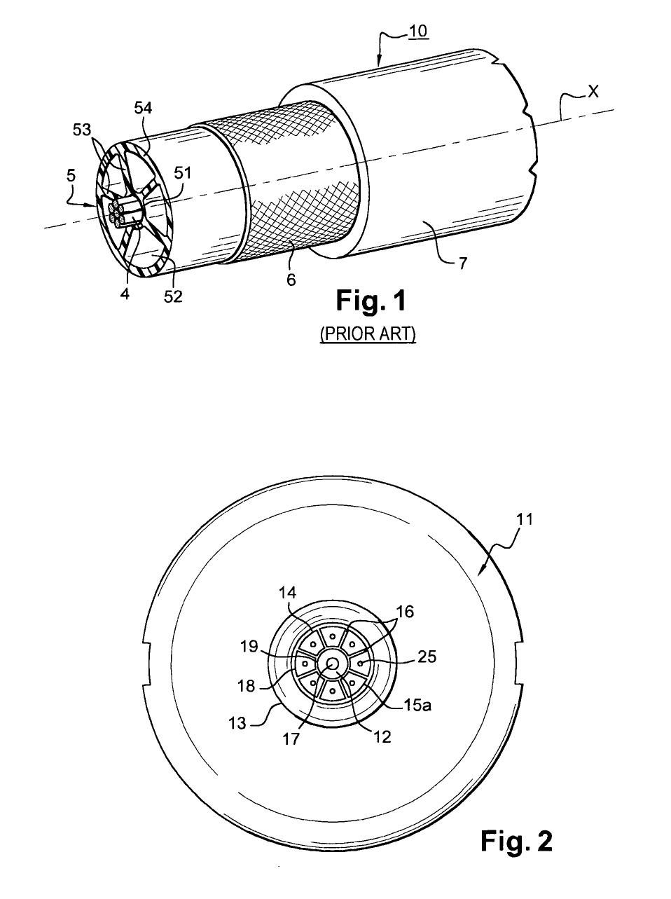

Note that identical or similar components or portions are designated by the same reference signs in FIGS. 2, 3 and 4.

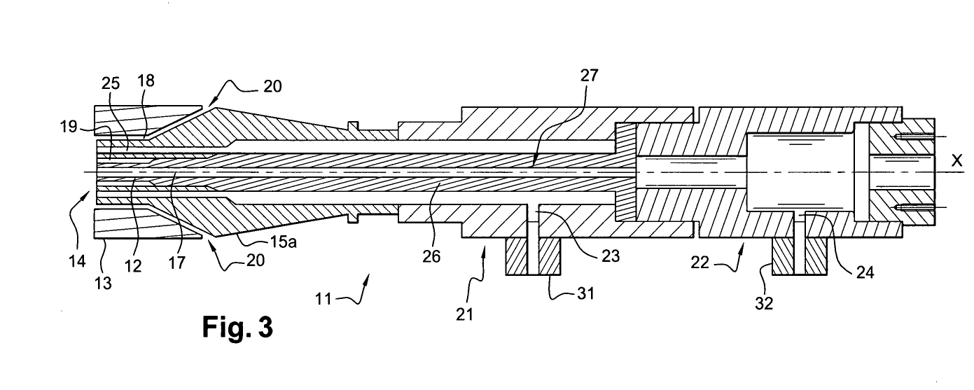

In the preferred embodiment of the present invention, a device 11 for fabricating a cellular sheath comprises a central guide 12 and a peripheral guide 13. The central guide 12 includes a longitudinal passage 17 adapted to receive a conductor that is not shown in FIGS. 2 and 3. An external surface of the central guide 12 and an internal surface of the peripheral guide 13 define a passage 14 adapted to receive an insulating material in a viscous state. The fabrication device 11 further includes a first sleeve 15a, a portion of which is adapted to be placed between the central guide 12 and the peripheral guide 13.

In the preferred embodiment of the present invention, the first sleeve 15a comprises eight radial openings 16 opening onto the central guide 12 and onto the peripheral guide 13.

The internal surface of the peripheral guide 13 and an external surface of the first sleeve 15a define a peripheral passage 18 adapted to receive the insulating material in the viscous state to form a peripheral wall of the cellular sheath.

An internal surface of the first sleeve 15a and the external surface of the central guide 12 define a central passage 19 adapted to receive the insulating material in the viscous state to form a central wall of the cellular sheath.

This kind of first sleeve 15a thus fabricates a cellular sheath with eight closed cells.

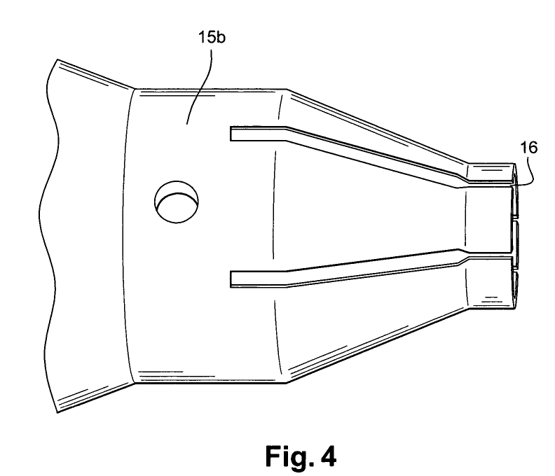

If a user, not shown, wishes to fabricate a cellular sheath having a configuration different from the configuration of the cellular sheath associated with the first sleeve 15a of FIGS. 2 and 3, the user replaces the first sleeve 15a. For example, a second sleeve 15b, part of which is shown in FIG. 4, may be used.

The second sleeve 15b is of generally similar shape to the first sleeve 15a but has a different number of radial openings 16, with the result that the second sleeve 15b produces a cellular sheath with only five cells.

Only a portion of the first sleeve 15a and a portion of the second sleeve 15b are crossed by the radial apertures 16, typically substantially the portions thereof adapted to be placed between the central guide 12 and the peripheral guide 13.

As shown in FIG. 3, the fabrication device 11 includes two feed passages 20 adapted to receive the insulating material in the viscous state and to guide the insulating material toward the passage 14. The insulating material in the viscous state then flows together via the peripheral passage 18 of the passage 14, the radial openings 16 and the central passage 19 to form the cellular sheath.

The preferred embodiment of the fabrication device 11 of the present invention includes a raised pressure chamber 21 and a reduced pressure chamber 22 adapted to be disposed on the longitudinal axis X of the fabrication device 11.

The raised pressure chamber 21 includes a blower passage 23 adapted to communicate with a first connector 31 so that the raised pressure chamber 21 can communicate with a blower pipe, not shown.

The reduced pressure chamber 22 includes a suction passage 24 adapted to communicate with a second connector 32 so that the reduced pressure chamber 22 can communicate with a suction pipe, not shown.

The first sleeve 15a and the second sleeve 15b include longitudinal vents 25. The raised pressure chamber 21 is adapted to communicate with each vent 25. If the raised pressure chamber 21 is also connected to the blower pipe, the gas inside each cell formed by the insulating material at the outlet of the sleeve has a sufficiently high pressure for the cells not to collapse, thereby maintaining the configuration of the cellular sheath.

The reduced pressure chamber 22 is adapted to communicate with the longitudinal passage 17. If the reduced pressure chamber 22 is connected to the suction pipe, the pressure around the conductor at the outlet of the central guide 12 is sufficiently low for the central wall of the cellular sheath formed to adhere to the conductor.

A tube 26 guarantees the seal between the portions of the fabrication device 11 communicating with the raised pressure chamber 21 and the portions of the fabrication device communicating with the reduced pressure chamber 22.

The tube 26 includes a reduced pressure passage 27 adapted to open into the reduced pressure chamber 22 and into the longitudinal passage 17 of the central guide 12. The tube 26 crosses the raised pressure chamber 21.

The reduced pressure chamber 22, the raised pressure chamber 21 and the tube 26 are removably fixed so that a user can easily assemble and dismantle the fabrication device 11.

What is claimed is:

1. A device for fabricating an insulating material cellular sheath around a conductor, the fabrication device comprising:
a central guide including a longitudinal passage adapted to receive the conductor and further having a peripheral guide, an internal surface of the peripheral guide and an external surface of the central guide defining a passage adapted to receive said insulating material in a viscous state, and
a sleeve separate from the central guide and the peripheral guide, at least a portion of the sleeve being adapted to be placed between the central guide and the peripheral guide and including an opening that opens onto the central guide and onto the peripheral guide.

2. A fabrication device according to claim 1, wherein an internal surface of the sleeve and the external surface of the central guide define a central passage adapted to receive the insulating material in the viscous state when the sleeve is placed between the central guide and the peripheral guide.

3. A device according to claim 1 for fabricating a cellular sheath, the device further comprising a reduced pressure chamber adapted to communicate with a suction pipe and with the longitudinal passage of the central guide so that at the outlet of the central guide the insulating material is pressed against the conductor.

4. A device according to claim 1 for fabricating a cellular sheath, in which device the sleeve includes one or more longitudinal vents for at least partly balancing the pressure between the ends of the sleeve.

5. A device according to claim 4 for fabricating a cellular sheath, the device further comprising a raised pressure chamber adapted to communicate with a blower pipe and with the vent or with each vent.

6. A device according to claim 5 for fabricating a cellular sheath, the device further comprising a reduced pressure chamber adapted to communicate with a suction pipe and with the longitudinal passage of the central guide so that at the outlet of the central guide the insulating material is pressed against the conductor, and in which device the reduced pressure chamber and the raised pressure chamber are adapted to be placed coaxially with a longitudinal axis of the fabrication device, the fabrication device further having a tube including a reduced pressure passage adapted to open into the reduced pressure chamber and into the longitudinal passage of the central guide.

7. A device according to claim 6 for fabricating a cellular sheath, in which device the tube crosses the raised pressure chamber.

8. A method of fabricating a cellular sheath using the device according to claim 6 and comprising a step of suction via the suction pipe and a step of blowing via the blowing passage, the suction step and the blowing step taking place conjointly.
